(19) United States
(12) Patent Application Publication
(10) Pub. No.: US 2010/0327728 A1
(43) Pub. Date: Dec. 30, 2010

(54) METHOD FOR PRODUCING RESIN COMPOSITION, RESIN COMPOSITION, REFLECTION PLATE AND LIGHT-EMITTING DEVICE

(75) Inventors: Shintaro SAITO, Tsukuba-shi (JP); Mitsuo Maeda, Tsukuba-shi (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY, LIMITED, Tokyo (JP)

(21) Appl. No.: 12/823,580

(22) Filed: Jun. 25, 2010

(30) Foreign Application Priority Data
Jun. 30, 2009 (JP) 2009-154610

(51) Int. Cl. F21V 7/22; C08J 3/22

(52) U.S. Cl. 313/113; 523/351; 252/589

(57) ABSTRACT

The present invention provides a method for producing a resin composition comprising a thermoplastic resin and a filler, the method comprising providing an extrusion granulator that comprises (i) a cylinder provided with an outlet, a first feed port and a second feed port located downstream from the first feed port but upstream from the midpoint between the first feed port and the outlet and (ii) at least one screw mounted in the cylinder; feeding the thermoplastic resin and the filler into the cylinder wherein the thermoplastic resin is fed through the first feed port and at least part of the filler is fed through the second feed port; kneading the thermoplastic resin and the filler while transporting them towards the outlet to provide a mixture; and extruding the mixture to produce the composition.

### BACKGROUND OF THE INVENTION

1. Field of the Invention

The present invention relates to a method for producing a resin composition, including the step of dispersing fillers such as titanium oxide in a thermoplastic resin such as liquid crystalline polyester, a resin composition produced thereby, a reflecting plate and a light-emitting device formed, which is formed by using the resin composition.

2. Description of the Related Art

Hitherto, a technology to form a reflection plate for a light-emitting device of a resin composition is known. The reflection plate made of the resin composition is superior in workability and lightness to reflection plates formed of inorganic materials. On the contrary, the reflection plates made of the resin composition are generally inferior in an optical reflectance and a heat conductivity to the reflection plates made of inorganic materials. Therefore, it is desired to enhance the optical reflectance and the heat conductivity of the resin composition for increasing practical utility of the reflection plates made of the resin composition.

As a method of enhancing the optical reflectance and the heat conductivity of the resin composition, for example, a method of filling an inorganic compound in a resin to disperse the compound in the resin is known. When a inorganic filler is used, it is preferred to use a liquid crystalline polyester as a resin. The liquid crystalline polyester has, compared with another kind of a resin, an advantage that fluidity and mechanical strength can be maintained at a sufficiently high level even when the inorganic filler is filled in a high concentration. In addition to this, the liquid crystalline polyester has also an advantage that a level of heat resistance is high and fabrication of a thin-wall is easy. Accordingly, it is thought that an excellent reflection plate can be obtained by using a liquid crystalline polyester as a resin and selecting a material capable of increasing an optical reflectance as a filler.

A liquid crystalline polyester resin composition as a material for forming the reflection plate is disclosed in, for example, JP-A-2004-256673. The liquid crystalline polyester resin composition of JP-A-2004-256673 has an advantage that whiteness degree is high, that is, a reflectance in a low wavelength range of visible light region is high in addition to the advantage of the liquid crystalline polyester resin composition described above.

### SUMMARY OF THE INVENTION

In an industrial production process of resin compositions, for example, an extruding granulating machine is used as a means of dispersing fillers. The extruding granulating machine is an apparatus to knead substances to be kneaded in a cylinder with a screw disposed in the cylinder. The substances to be kneaded are moved downstream with a rotation of the screw and extruded outward from a nozzle at a downstream end. The extruding granulating machine includes a single-screw extruding granulating machine (number of screws is one) and a multi-screw extruding granulating machine (number of screws is two or more), and generally a twin-screw extruding granulating machine is often used.

Hitherto, in the step of dispersing fillers using the extruding granulating machine, the resin composition and the fillers have been fed simultaneously to the cylinder while heating the cylinder with a heater. Then, these materials have been kneaded with the screw to disperse the fillers.

However, the conventional step of dispersing fillers has a disadvantage that it is difficult to uniformly disperse the inorganic fillers when a resin composition having low viscosity such as liquid crystalline polyester is used. This disadvantage is particularly remarkable when the inorganic fillers are fine and have a high packing density.

In addition to this, when the fine inorganic fillers are filled in a high concentration, since the inorganic fillers are apt to slip against the screw, there is disadvantage that defective bite is produced. The occurrence of the defective bite tends to cause variations in resin composition and makes it difficult for the resin composition to move downstream to deteriorate the productivity.

It is an object of the present invention to provide a technology to uniformly disperse fillers and suppress the occurrence of defective bite in dispersing fillers in a resin composition.

In order to achieve such an object, the present inventors decided to feed the thermoplastic resin and the fillers from different positions to the cylinder.

Namely, the present invention provides a method for producing a resin composition comprising a thermoplastic resin and a filler dispersed therein, the method comprising:
providing an extrusion granulator that comprises (i) a cylinder provided with an extrusion outlet, a first feed port and a second feed port located downstream from the first feed port but upstream from the midpoint between the first feed port and the extrusion outlet and (ii) at least one screw mounted in the cylinder;
feeding the thermoplastic resin and the filler into the cylinder wherein the thermoplastic resin is fed through the first feed port and at least part of the filler is fed through the second feed port;
kneading the thermoplastic resin and the filler while transporting them towards the outlet by rotating the at least one screw to provide a mixture of them; and
extruding the mixture to produce the resin composition.

Also, the present invention provides a resin composition produced by the method described above. Further, the present invention provides a reflection plate produced by using the resin composition; and also provides a light-emitting device comprising a light-emitting element and the reflection plate to reflect light emitted from the light-emitting element.

In accordance with the inventions according to each claim described above, since a feed position is separated into the first feed port from which the thermoplastic resin is fed on an upstream side and the second feed port from which the granular fillers are fed on a downstream side, the fillers can be more uniformly dispersed than a conventional method and the defective bite can be suppressed.

In accordance with the invention according to claim 11, since the fillers can be uniformly dispersed and the defective bite can be suppressed in producing the resin composition, it is possible to provide a resin composition having less unevenness in characteristics such as an optical reflectance and a heat conductivity at low cost.

In accordance with the invention according to claim 12, since the fillers can be uniformly dispersed and the defective bite can be suppressed in producing the resin composition, it is possible to provide a reflection plate having less unevenness in characteristics such as an optical reflectance and a heat conductivity and less product variations at low cost.

In accordance with the invention according to claim 13, since the fillers can be uniformly dispersed and the defective bite can be suppressed in producing the resin composition, it is possible to provide a light-emitting device having less unevenness in characteristics such as an optical reflectance and a heat conductivity and less product variations at low cost.

### BRIEF DESCRIPTION OF THE DRAWINGS

FIG. 1 is a conceptual sectional view showing a structure of a twin-screw extruding granulating machine used in one embodiment of the present invention.

### DETAILED DESCRIPTION OF THE PREFERRED EMBODIMENT

A resin composition produced in the present invention comprises a thermoplastic resin and a filler dispersed in the resin. The resin composition can be produced by a method comprising:
providing an extrusion granulator that comprises (i) a cylinder provided with an extrusion outlet, a first feed port and a second feed port located downstream from the first feed port but upstream from the midpoint between the first feed port and the extrusion outlet and (ii) at least one screw mounted in the cylinder;
feeding the thermoplastic resin and the filler into the cylinder wherein the thermoplastic resin is fed through the first feed port and at least part of the filler is fed through the second feed port;
kneading the thermoplastic resin and the filler while transporting them towards the outlet by rotating the at least one screw to provide a mixture of them; and
extruding the mixture to produce the resin composition.

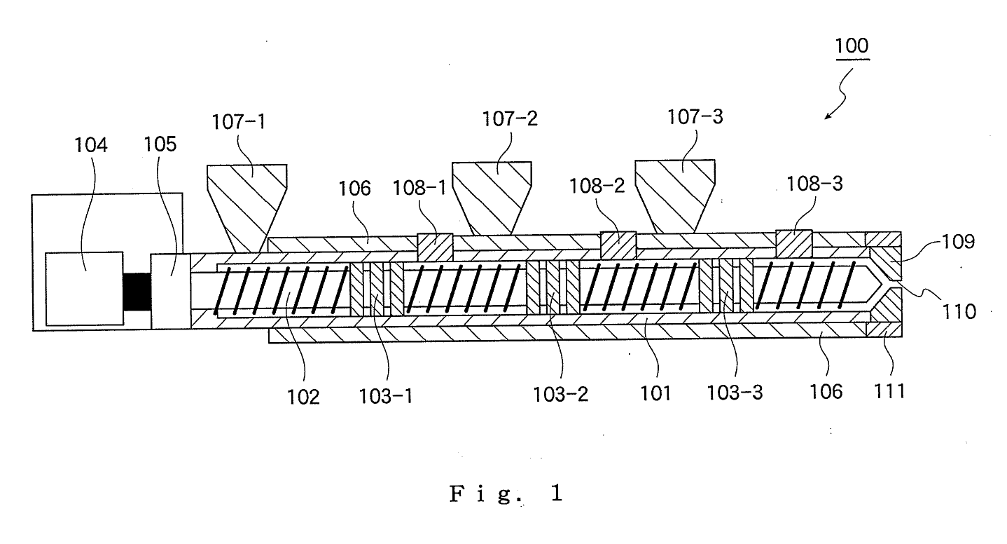

Hereinafter, an embodiment of the present invention will be described by use of FIG. 1.

First, a production method of the present embodiment, that is, a method of dispersing fillers in a thermoplastic resin by using an extruding granulating machine will be described

### <Extruding Granulating Machine>

In the present embodiment, the fillers are dispersed in a thermoplastic resin by using a twin-screw extruding granulating machine. The twin-screw extruding granulating machine is a melt-kneading extruder including twin-screws.

The twin-screw extruding granulating machine is classified in a type of a rotation in the same direction, a type of a rotation in different directions and a type of an incomplete engaging rotation according to a rotary system of the screw. Furthermore, the twin-screw extruding granulating machine of the rotation in the same direction includes machines of a single thread, a double thread and a triple thread, and the twin-screw extruding granulating machine of the rotation in different directions includes machines of a parallel axis type and an inclined axis type. In the present embodiment, the extruding granulating machine will be described taking, as an example, the twin-screw extruding granulating machine of the rotation in the same direction having a single thread.

FIG. 1 is a conceptual view schematically showing a structure of a twin-screw extruding granulating machine 100 used in the present embodiment.

In the twin-screw extruding granulating machine 100 in FIG. 1, a cylinder 101 is a vessel for kneading the resin composition and the fillers.

A screw 102 is disposed in the cylinder 101. In addition, since the extruding granulating machine 100 of the present embodiment is a twin-screw type, it includes two screws in practice, but only one screw 102 is shown in FIG. 1. Here, it is desirable that the screw 102 is configured so as to be a screw with a positive direction thread (that is, a screw with a thread configured so as to transport the substances to be kneaded to a direction of extrusion) relative to a direction of extrusion at a downstream part from the downstream feed port 107-3 (described later). For example, by employing a full flight screw as the screw 102, the thermoplastic resin and the fillers can be transported in a direction of extrusion with efficiency. Accordingly, a reduction in a molecular weight of a melted resin can be suppressed.

Kneading sections 103-1, 103-2, and 103-3 are disposed on the screw 102. By disposing these kneading sections 103-1, 103-2, and 103-3, it becomes possible to knead the thermoplastic resin and the like with efficiency fed to the inside of the cylinder 101 and therefore the dispersibility of the fillers can be improved. As the kneading sections 103-1, 103-2, and 103-3, a kneading disk (a right-kneading disk, a neutral-kneading disk and a left-kneading disk), and a mixing screw can be used.

A motor 104 is connected to the screw 102 through a transmission 105. Thereby, the motor 104 can rotationally drive the screw 102 and the transmission 105 can adjust a rotation speed.

A heater 106 is arranged so as to cover an outer surface of the cylinder 101 and used for heating the inside of the cylinder 101. A heating method of the heater 106 is not particularly limited and for example, an aluminum casting heater, a brass casting heater, a band heater, a space heater and the like can be employed. The heater 106 may be composed of plural heating parts.

Feed ports 107-1, 107-2, and 107-3 are used for feeding substances to be kneaded to the cylinder 101. The feed ports 107-1, 107-2, and 107-3 each include a feed opening (not shown) for feeding substances to be kneaded to the inside of the cylinder 101 and a hopper for guiding the substances to be kneaded to these feed openings. The upstream feed port 107-1 is disposed in the vicinity of the upstream end of the cylinder 101. The intermediate feed port 107-2 is disposed upstream from a center of the upstream feed port 107-1 and the downstream end of the cylinder 101. The downstream feed port 107-3 is disposed downstream from the intermediate feed port 107-2. In addition, a quantitative feeder for feeding the substances to be kneaded quantitatively to the inside of the cylinder 101 may be provided at these feed ports 107-1, 107-2 and 107-3. As described later, in the present embodiment, the thermoplastic resin (for example, liquid crystalline polyester) is fed from the upstream feed port 107-1. Further, a portion of a filler A (for example, titanium oxide) described later or a portion of a filler B (for example, glass fiber) described later may be fed from the upstream feed port 107-1. The rest of the filler A is fed from the intermediate feed port 107-2. Further, a portion of the thermoplastic resin or a portion of the filler B may be fed from the intermediate feed port 107-2. The filler B is fed from the downstream feed port 107-3 as required. Moreover, a portion of the thermoplastic resin or a portion of the filler A may be fed from the downstream feed port 107-3.

A plurality (three in the case of FIG. 1) of vents 108-1, 108-2 and 108-3 are disposed in the cylinder 101. The vents 108-1, 108-2 and 108-3 are connected to a vacuum pump (not shown). Thereby, the inside of the cylinder 101 can be evacuated. Further, the vents 108-1, 108-2 and 108-3 may be used merely for the purpose of releasing a gas in the cylinder 101 to an atmosphere without connecting the vacuum pump to these vents 108-1, 108-2 and 108-3. In the production step of the present embodiment, a gas of causing the strands to be significantly brittle is not produced, but it is preferred to discharge a generated gas by evacuation. Further, when the gas is evacuated by use of only the vent 108-3 which is located at extreme downstream side, the generated gas can be discharged with efficiency.

A dice 109 is disposed at a downstream end of the cylinder 101. A nozzle 110 for extruding the substances to be kneaded is provided in the dice 109. The dice 109 is heated with a heater 111 for a dice.

Hereinafter, the thermoplastic resin and the fillers A,

B fed to the twin-screw extruding granulating machine 100 of FIG. 1 will be described in detail.

### <Thermoplastic Resin>

In the present embodiment, liquid crystalline polyester is used as the thermoplastic resin. The liquid crystalline polyester to be used in the present embodiment is polyester also referred to as thermotropic liquid crystalline polyester and forms a melt exhibiting optical anisotropy at a temperature of 450° C. or lower. Specific examples of the liquid crystalline polyester include the following:

(1) liquid crystalline polyesters obtained by polymerizing a combination of an aromatic hydroxycarboxylic acid, an aromatic dicarboxylic acid and an aromatic diol;
(2) liquid crystalline polyesters obtained by polymerizing two or more kinds of aromatic hydroxycarboxylic acids;
(3) liquid crystalline polyesters obtained by polymerizing a combination of an aromatic dicarboxylic acid and an aromatic diol; and
(4) liquid crystalline polyesters obtained by reacting an aromatic hydroxycarboxylic acid with a crystalline polyester such as polyethylene terephthalate or the like.

Here, in the production of the liquid crystalline polyester, in place of the aromatic hydroxycarboxylic acid, the aromatic dicarboxylic acid or the aromatic diol, an ester-forming derivative thereof may also be used. The use of such an ester-forming derivative facilitates the production of the liquid crystalline polyester.

Hereinafter, the ester-forming derivative will be briefly described.

Examples of the ester-forming derivatives include derivatives having a carboxyl group in its molecule (for example, aromatic hydroxycarboxylic acid, aromatic dicarboxylic acid), and derivatives having a phenolic hydroxyl group in its molecule (for example, aromatic hydroxycarboxylic acid and aromatic diol). Examples of ester-forming derivatives having a carboxyl group include derivatives obtained by converting the carboxyl group to a highly reactive acid halide group or an acid anhydride group; and derivatives in which the carboxyl group forms esters with alcohols or ethylene glycol which form a polyester by trans-esterification, and the like. Further, examples of the ester-forming derivatives having a phenolic hydroxyl group in its molecule may include those in which the phenolic hydroxyl group forms esters with lower carboxylic acids in such a manner as to form a polyester by trans-esterification, and the like.

Moreover, in the above aromatic hydroxycarboxylic acid, aromatic dicarboxylic acid or aromatic diol may, a part of or all of hydrogen atoms in its aromatic ring may be replaced with a halogen atom such as a chlorine atom or a fluorine atom; an alkyl group such as a methyl group or an ethyl group; or an aryl group such as a phenyl to such an extent that the ester-forming ability is not impaired.

Examples of a structural unit that can form the liquid-crystalline polyester include the following structures.

Structural units derived from the aromatic hydroxycarboxylic acid may include:

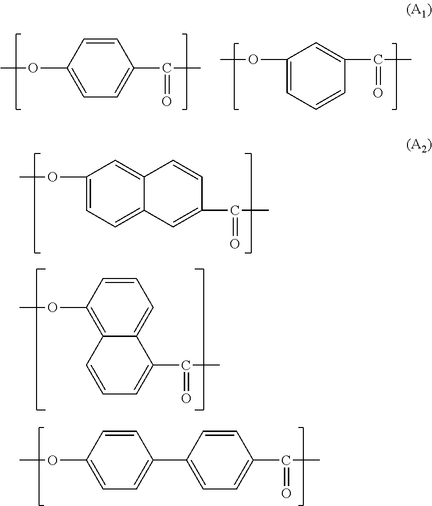

These structural units may have a halogen atom, an alkyl group or an aryl group as a substituent.

Structural units derived from the aromatic dicarboxylic acid may include:

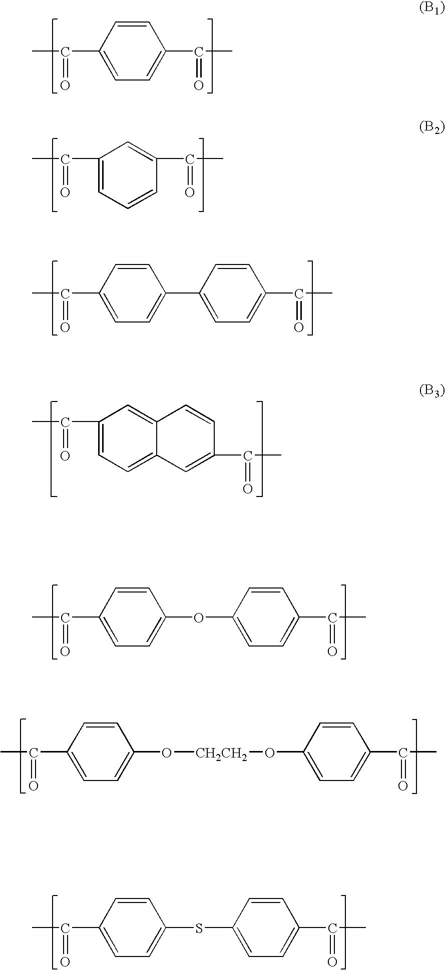

These structural units may have a halogen atom, an alkyl group or an aryl group as a substituent.

Structural units derived from the aromatic diol may include:

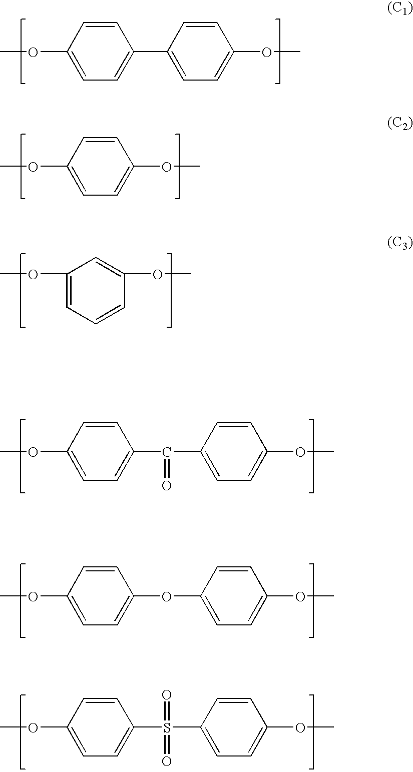

These structural units may have a halogen atom, an alkyl group or an aryl group as a substituent.

Preferred combinations of structural units for the liquid-crystalline polyester include the following combinations (a) to (h), each unit being represented by the structural units shown in the above examples.
(a): a combination of the units (A₁), (B₁) and (C₁), or a combination of the units (A₁), (B₁), (B₂) and (C₁)
(b): a combination of the units (A₂), (B₃) and (C₂), or a combination of the units (A₂), (B₁), (B₃) and (C₂)
(c): a combination of the units (A₁) and (A₂)
(d): a combination (a) of structural units in which the unit (A₁) is partly or entirely substituted with the unit (A₂)
(e): a combination (a) of structural units in which the unit (B₁) is partly or entirely substituted with the unit (B₃)
(f): a combination (a) of structural units in which the unit (C₁) is partly or entirely substituted with the unit (C₃)
(g): a combination (b) of structural units in which the unit (A₂) is partly or entirely substituted with the unit (A₁)
(h): a combination (c) of structural units added with the units (B₂) and (C₂)

As described above, the liquid crystalline polyester to be used in the present embodiment is preferably a liquid crystalline polyester having (A₁) and/or (A₂) as a structural unit derived from an aromatic hydroxycarboxylic acid, having at least anyone of (B₂), (B₂) and (B₃) as a structural unit derived from an aromatic diol, and having at least any one of (C₁), (C₂) and (C₃) as a structural unit derived from an aromatic dicarboxylic acid.

When the resin composition of the present embodiment is used for a reflection plate of an LED light-emitting device, a liquid crystalline polyester having a flow temperature of preferably 270 to 400° C. is employed as the liquid crystalline polyester, and more preferably 300 to 380° C. When the reflection plate is formed of a liquid crystalline polyester having a flow temperature lower than 270° C., there is a possibility that the reflection plate may be deformed or may produce a blister (abnormal blistering) in a high temperature environment such as the step of fabricating an LED module or the like. On the other hand, when the reflection plate is formed of a liquid crystalline polyester having a flow temperature higher than 400° C., a temperature of melt-processing is too high and unsuitable for the production of the reflection plate. Here, the flow temperature used herein means a temperature at which a heat melt has melt viscosity of 4800 Pa·sec when the heat melt is extruded from a nozzle at a temperature rise rate of 4° C./min under a load of 9.8 MPa by using a capillary type rheometer provided with a nozzle having an inner diameter of 1 mm and a length of 10 mm. This flow temperature is a measure representing the molecular weight of a liquid crystalline polyester (see, Naoyuki Koide (edition), “Liquid Crystal Polymer•Synthesis Molding •Application”, pp 95-105, CMC, published on Jun. 5, 1987).

The method for producing a liquid crystalline polyester of the present embodiment is not particularly limited and various publicly known methods can be employed. However, when the resin composition of the present embodiment is used in an LED light-emitting device, the method capable of producing a liquid crystalline polyester having a YI (Yellowness Index) value of 32 or smaller, which has been proposed by the applicant of the present application in Japanese patent application Serial No. 2003-48945 (JP-A-2004-256673), is desirable.

Hereinafter, the method for producing a liquid crystalline polyester disclosed in Japanese patent application Serial No. 2003-48945 will be described.

In this method, first, a fatty acid anhydride is mixed in a mixture of an aromatic hydroxycarboxylic acid, an aromatic diol and an aromatic dicarboxylic acid and then the resulting mixture is reacted at 130 to 180° C. in a nitrogen atmosphere to acylate the hydroxyl groups of the aromatic hydroxycarboxylic acid and aromatic diol with the fatty acid anhydride. By heating an acylated product (acylated aromatic hydroxycarboxylic acid and acylated aromatic diol) thus obtained, trans-esterification is caused between the acyl groups of these acylated products and the carboxyl groups of the acylated aromatic hydroxycarboxylic acid and aromatic dicarboxylic acid while distilling off reaction byproducts out of the reaction system to perform polycondensation and thereby a liquid crystalline polyester is obtained.

In the mixture of the aromatic hydroxycarboxylic acid, the aromatic diol and the aromatic dicarboxylic acid, the molar ratio of the hydroxyl group to the carboxyl group is preferably from 0.9 to 1.1.

The amount of the fatty acid anhydride to be used is preferably from 0.95 to 1.2 equivalents, and more preferably from 1.00 to 1.12 equivalents with respect to one equivalent of the total amount of the phenolic hydroxyl groups of the aromatic hydroxycarboxylic acid and the aromatic diol. By reducing the amount of the fatty acid anhydride to be used, coloring of the liquid crystalline polyester can be suppressed. However, when the amount of the fatty acid anhydride to be used is too small, there may be cases where an unreacted aromatic diol or aromatic dicarboxylic acid is easily sublimated during the polycondensation, causing the reaction system to be clogged. On the other hand, when the amount of the fatty acid anhydride to be used is more than 1.2 equivalents, coloring of a liquid crystalline polyester to be produced cannot be neglected and there is a possibility that a color tone of one to be produced may be deteriorated.

Examples of the fatty acid anhydride include, which are not limited to, acetic anhydride, propionic anhydride, butyric anhydride, isobutyric anhydride, valeric anhydride, pivalic anhydride, 2-ethylhexanoic anhydride, monochloroacetic anhydride, dichloroacetic anhydride, trichloroacetic anhydride, monobromoacetic anhydride, dibromoacetic anhydride, tribromoacetic anhydride, monofluoroacetic anhydride, difluoroacetic anhydride, trifluoroacetic anhydride, glutaric anhydride, maleic anhydride, succinic anhydride, and β-bromopropionic anhydride. Mixture of two or more kinds of these may be used. From the viewpoints of the cost and the handling, acetic anhydride, propionic anhydride, butyric anhydride, and isobutyric anhydride are preferably used, and the acetic anhydride is more preferably used.

Ester exchange (polycondensation) reaction is conducted preferably at a temperature of from 130 to 400° C. elevating at a rate of 0.1 to 50° C./minute, and more preferably at a temperature of from 150 to 350° C. elevating at a rate of 0.3 to 5° C./minute.

In the foregoing production method disclosed in Japanese Unexamined Patent Publication No. 2004-256673 (Application No. 2003-48945), the ester exchange (i.e., polycondensation) reaction is preferably conducted in the presence of a heterocyclic organic base compound containing two or more nitrogen atoms (i.e., nitrogen-containing heterocyclic organic base compound) from the viewpoint of further smoothening production of the liquid-crystalline polyester and sufficiently suppressing coloring of the obtainable liquid-crystalline polyester. Examples of the nitrogen-containing heterocyclic organic base compound include imidazole compounds, triazole compounds, dipyridinyl compounds, phenanthroline compounds and diazaphenanthrene compounds. Among these, imidazole compounds are preferably used from the viewpoint of reactivity, and 1-methylimidazole and 1-ethylimidazole are more preferably used because of their availability.

For the purpose of increasing the polycondensation rate by further promoting the transesterification (polycondensation) reaction, catalysts other than the heterocyclic organic base compound may also be used. However, in the case where a metal salt or the like is used as the catalyst, since the metal salt remains as impurities in the liquid crystalline polyester, there is an adverse influence on electronic parts such as a reflecting plate in some cases. On the other hand, when the nitrogen-containing heterocyclic organic base compound is used as the catalyst, such an adverse influence is hardly produced and the nitrogen-containing heterocyclic organic base compound is particularly suitable as the catalyst at the time when the liquid crystalline polyester of the present embodiment is produced.

Examples of a method of further proceeding with the ester exchange (polycondensation) reaction to increase a polymerization degree of liquid-crystalline polyester include a method in which the ester exchange (polycondensation) reaction is conducted while reducing internal pressure in a reaction vessel (i.e., reduced pressure polymerization), and a method in which a reaction product obtained after the ester exchange (polycondensation) reaction is cooled and then solidified, then the product is ground into a powder form, and the obtained powder reaction product is solid-phase polymerized in a condition of, for example, 250 to 350° C. for 2 to 20 hours. By increasing the polymerization degree in such a manner, a liquid-crystalline polyester having a desirable flow starting temperature can be easily produced. A solid-phase polymerization is preferably employed from the viewpoint that the facility is simple.

Here, the polycondensation in which the aforementioned acylation reaction and ester exchange reaction are combined, the reaction for increasing the degree of polymerization (for example, the reduced pressure polymerization) or the solid-phase polymerization) and the like are preferably conducted in an atmosphere of inert gas such as nitrogen.

The liquid-crystalline polyester thus produced may be a liquid-crystalline polyester exhibiting a YI value of 32 or less and is particularly preferred as the thermoplastic resin used in the present embodiment. Here, the YI value is a value obtained by measurement of a test piece made of the liquid-crystalline polyester by means of a color difference meter. The YI value is an index representing yellowness of an object, is defined in the D1925 standard of the American Society for Testing and

Materials (ASTM), and can be determined using the following formula (1):

YI=[100(1.28X−1.06Z)/Y] (1)

(wherein X value, Y value and Z value respectively represent tristimulus values in a XYZ color system.)

While the liquid-crystalline polyester having a YI value of 32 or less obtained in the production method using the heterocyclic organic base compound is particularly preferable, a mixture of liquid-crystalline polyesters exhibiting a YI value of 32 or less (which may be obtained by mixing plurality of kinds of liquid-crystalline polyesters) is also preferable. Since the YI value of the mixture of the plurality of kinds of liquid-crystalline polyesters (liquid-crystalline polyester mixture) can be determined in the same manner as described above, it is possible to select a mixture of the liquid-crystalline polyesters preferred for use as the liquid crystalline polyester of the present embodiment.

### <Filler A>

The filler A is a filler fed from the intermediate feed port 107-2. Further, as described above, a portion of the filler A may be fed from the upstream feed port 107-1.

Examples of the filler A include fillers made of inorganic compounds; for example, pigments such as iron oxide, ultramarine blue pigment, zinc oxide, zinc sulfide, lead white, and titanium oxide; inorganic fibers such as glass fibers, carbon fibers, metal fibers, alumina fibers, boron fibers, titanic acid fibers, wollastonite and asbestos; powders such as silicon dioxide, calcium carbonate, alumina, aluminum hydroxide, kaolin, talc, clay, mica, glass flake, glass beads, dolomite, various metal powders, barium sulfate, potassium titanate and calcined gypsum; and granular, plate-like or whisker-like inorganic compounds such as silicon carbide, alumina, boron nitride, aluminum borate or silicon nitride.

A particle diameter of the filler A is not particularly limited. However, when the particle diameter of the filler A is large enough, the problems of the present invention (described above) such as deterioration of dispersibility and defective bite hardly arise and therefore the effect achieved by the production method of the present embodiment is large when an average particle diameter of the filler A is small. That is, when the particle diameter is small, since a bulk density is small and a bite property of the screw is deteriorated, the effect of the production method of the present embodiment is exerted. From such a viewpoint, in the present embodiment, a volume-average particle diameter of the filler A is preferably 0.05 to 20 μm, more preferably 0.1 to 15 μm, furthermore preferably 0.15 to 10 μm, and most preferably 0.17 to 5 μm.

In the present embodiment, the average particle diameter is determined based on the longest dimension of the particle of the filler A. When the fillers A are adequately coagulated in a solvent for measuring an average particle diameter (titanium oxide, etc.), first, an outward appearance of a filler is measured by a scanning electron microscope (SEM). Furthermore, the obtained SEM photograph is subjected to an image analyzer (for example, “Luzex IIIU” manufactured by Nireco Corp.) to determine a distribution curve by plotting the amount of particles (%) in each particle size interval of primary particles. Then, a particle diameter at the degree of accumulation of 50% (in terms of particle volumes) is calculated from the cumulative distribution curve as the volume average particle diameter. On the other hand, when the fillers A are not adequately coagulated in a solvent for measuring an average particle diameter, the average particle diameter can be measured by a laser diffraction method

A compounded amount of the filler A is not particularly limited, but when the compounded amount is small, the problems of the present invention hardly arise and therefore the effect achieved by the production method of the present embodiment is large when the compounded amount of the filler A is large. On the other hand, when the compounded amount is too large, production itself in accordance with the method of the present embodiment tends to be difficult. From such a viewpoint, the compounded amount of the filler A is preferably 20 to 200 parts by weight, more preferably 25 to 150 parts by weight, and furthermore preferably 40 to 100 parts by weight based on 100 parts by weight of the thermoplastic resin. When a mixture of a plurality of fillers is used as the filler A, a total amount of the mixture may be within such a range of the compounded amount

In the production method of the present embodiment, titanium oxide is used as the filler A. The titanium oxide filler may be a titanium compound which is primarily made of titanium oxide and may include impurities unintentionally contained. In principle, a material which is commercially available as titanium oxide for a resin filler may be used as it is as the filler A of the present embodiment. As the filler A of the present embodiment, a titanium oxide which has been surface-treated as described later may also be used.

A crystal shape of titanium oxide to be contained in the filler A is not particularly limited, and a rutile type, anatase type or a mixture thereof may be used. However, when a reflection plate is prepared by using the resin composition of the present embodiment, a filler containing rutile type titanium oxide is preferably used as the filler A and a filler consisting of rutile type titanium oxide is more preferably used as the filler A in order to attain a high reflectance and excellent weather resistance.

Also when the titanium oxide is used, the average particle diameter of the filler A is not particularly limited. However, when a reflection plate is prepared by using the resin composition of the present embodiment, it is preferred to appropriately select the average particle diameter according to a thickness of the reflection plate in order to attain a high reflectance and adequately enhance the uniformity in dispersion of the filler A. While an optimum average particle diameter varies depending on the conditions such as a thickness of the reflection plate, generally, the average particle diameter is preferably 0.1 to 1 μm, more preferably 0.15 to 0.5 μm, and furthermore preferably 0.18 to 0.4 μm.

When the titanium oxide is used as the filler A, the titanium oxide may be surface treated. For example, by surface treating by use of an inorganic metal oxide, there may be cases where characteristics such as dispersibility and weather resistance can be improved. As the inorganic metal oxide, for example, aluminum oxide (i.e., alumina) is preferably used. However, it is preferred to use titanium oxide not surface treated from the viewpoint of heat resistance and strength if it is free from coagulation and there is not a problem of handling.

A method for producing titanium oxide is not particularly limited, and for example, a chlorine method may be employed, or a sulfuric acid method may be employed. However, when rutile type titanium oxide is used as the filler A, the chlorine method is preferably used. Further, it is preferred to select production conditions under which titanium oxide having an average particle diameter described above is easily obtained. When titanium oxide is produced using the chlorine method, first, ores (rutile ore, or synthetic rutile obtained from ilmenite ore), which are titanium sources, are reacted with chlorine at about 1000° C. to produce a crude titanium tetrachloride, and the crude titaniumtetrachloride is refined by distillation to obtain titaniumtetrachloride. The titaniumtetrachloride is oxidized by oxygen to obtain titanium oxide. If the chlorine method is employed, a resin composition excellent in whiteness (i.e., reflectance in a low wavelength range of visible light region) is easily obtained by appropriately setting the conditions in the oxidation step. Further, by optimizing the conditions in the oxidation step, the production of coarse particles is suppressed, making it easy to obtain a desired average diameter.

Examples of the titanium oxides which can be used as a filler A include “TIPAQUE CR-60” and “TIPAQUE CR-58”, manufactured by Ishihara Sangyo Kaisha, Ltd., as titanium oxide produced by a chlorine method. Further, examples of the titanium oxide produced by a sulfuric acid method include “TITANIX JR-301” and “WP0042”, manufactured by TAYCA Corp., and “SR-1”, “SR-1R” and “D-2378”, manufactured by Sakai Chemical Industry Co., Ltd.

### <Filler B>

In the production method of the present embodiment, the filler B may be fed from the downstream feed port 107-3 in addition to the filler A. The filler B is fed, for example, in the case where improvements in mechanical properties of a reflection plate prepared by using the resin composition of the present embodiment is desired.

As the filler B, there can be used inorganic fibers such as glass fibers, carbon fibers, metal fibers, alumina fibers, boron fibers, titanic acid fibers, wollastonite, asbestos, alumina, and calcium carbonate; powders such as silicon dioxide, kaolin, talc, clay, mica, glass flake, glass beads, hollow glass beads, dolomite, various metal powders, barium sulfate, potassium titanate and calcined gypsum; and granular, plate-like or whisker-like inorganic compounds such as silicon carbide, alumina, boron nitride, aluminum borate or silicon nitride.

Among these fillers, inorganic fibers such as glass fibers, titanic acid fibers and wollastonite; granular, plate-like or whisker-like inorganic compounds such as silicon dioxide, aluminum borate and silicon nitride; and talc are preferred from the viewpoint of imparting practical mechanical strength to the obtained reflecting plate while suppressing the deterioration of performance of the resin composition.

Though a binding agent may be used for the filler B, the amount of the binding agent to be used is preferably smaller form the viewpoint of suppressing deterioration in heat resistance of the liquid crystalline polyester.

The filler B preferably has a volume-average particle diameter of 20 μm or more, and more preferably has a volume-average particle diameter of more than 20 μm. By using the fillers having a relatively large average particle diameter, dispersibility and a feeding property can be more excellent than the filler A described above. Here, the volume-average particle diameter is an average particle diameter of the longest dimension measured in the same manner as in the filler A described above

The compounded amount of the filler B is not particularly limited, but it is desirably 5 to 100 parts by weight, and particularly desirably 5 to 90 parts by weight with respect to 100 parts by weight of the thermoplastic resin. When the compounded amount of the filler B is too large, reduction in characteristics of the resin composition cannot be neglected in the case where the filler A is highly filled or moldability becomes remarkable in the case where a small molded article is formed.

### <Additive>

In the production method of the present embodiment, in addition to the fillers A, B, usual additives, for example, releasability improvers such as fluororesins, higher fatty acid ester compounds and fatty acid metal soaps; coloring agents such as dyes and pigments; antioxidants; thermal stabilizers; fluorescent whitening agents; ultraviolet absorbers; antistatic agents; and surfactants, may be added within limits that do not impair the object of the present invention. Further, additives having external lubricating effects such as higher fatty acids, higher fatty acid esters, higher fatty acid metal salts and fluorocarbon type surfactants may be added.

### <Production Step of Resin Composition>

Next, the step of producing the resin composition of the present embodiment will be described.

First, heating of a cylinder 101 and a dice 13 is started. Heaters 106, 111 are used for this heating. It is preferred to set a setting temperature of the heater 106 at a temperature of (Tm±50)° C. taking a flow temperature (described above) of a liquid crystalline polyester as a thermoplastic resin as Tm.

After the cylinder 101 is heated, drive of a motor 104 is started. Thereby, a screw 102 starts to rotate.

Then, feeding of the thermoplastic resin (here, liquid crystalline polyester) from a first feed treatment namely an upstream feed port 107-1 to the inside of the cylinder 101 is started, and further feeding of the filler A (here, titanium oxide) from a second feed treatment namely an intermediate feed port 107-2 to the inside of the cylinder 101 is started. Thereby, the liquid crystalline polyester and the titanium oxide are kneaded with the screw 102 to diffuse the titanium oxide in the liquid crystalline polyester.

As described above, since the twin-screw extruding granulating machine 100 of the present embodiment includes kneading sections 103-1, 103-2, and 103-3, the liquid crystalline polyester and the titanium oxide can be kneaded with efficiency and therefore the dispersibility of the titanium oxide can be improved.

The kneaded liquid crystalline polyester and titanium oxide are gradually moved downstream and extruded from a nozzle 110.

It is desirable that a rotational speed of the screw 102 and an allowable torque of the motor 104 are larger. The reason for this is that when these values are large, a discharge rate from the nozzle 110 is large and productivity is improved. It is desirable to set the rotational speed of the screw 102 in such a manner that an extrusion rate increases as far as possible for the purpose of preventing the resin composition to be produced from undergoing significant heat history.

In the conventional step of producing a resin composition (i.e., production step in which both of a liquid crystalline polyester and titanium oxide are fed from the upstream feed port 107-1 to the inside of the cylinder 101), defective bite of the screw into the resin composition is produced in the case where the amount of the filled (supplied) titanium oxide is large and therefore the liquid crystalline polyester and the titanium oxide are not adequately sent downstream. Therefore, the liquid crystalline polyester and the titanium oxide build up in the vicinity of the upstream feed port 107-1 and this causes deterioration of the productivity and variations in resin composition. On the other hand, in the step of producing a resin composition of the present embodiment, since the liquid crystalline polyester is fed from the upstream feed port 107-1 and the titanium oxide is fed from the intermediate feed port 107-2, the defective bite at the upstream feed port 107-1 hardly occurs. Further, the titanium oxide can be fed while the liquid crystalline polyester is moved with the screw 102. As a result of this, in accordance with the present embodiment, the productivity can be improved and the variations in resin composition can be reduced, and furthermore the dispersibility of titanium oxide can be improved.

Here, in the present embodiment, a portion of the titanium oxide can also be fed from the upstream feed port 107-1 together with the liquid crystalline polyester. The reason for this is that if the amount of titanium oxide fed from the upstream feed port 107-1 is small enough, defective bite is not caused and there is not a possibility of causing the deterioration of productivity. That is, a portion of the titanium oxide may be fed from the upstream feed port 107-1 within limits that do not cause disadvantage such as defective bite. The amount of the titanium oxide to be fed which does not cause disadvantage depends on kinds of the thermoplastic resin or the filler A or various production conditions.

When a portion of the titanium oxide is fed from the upstream feed port 107-1, it is preferred that the liquid crystalline polyester and the titanium oxide are previously mixed using a ribbon blender, a Henschel mixer or a tumbler and the resulting mixture is charged into the upstream feed port 107-1. Thereby, dispersibility of the titanium oxide can be further improved.

Further, a portion of the liquid crystalline polyester may be fed from the intermediate feed port 107-2.

Moreover, in the present embodiment, the filler B may be fed from the downstream feed port 107-3 to the inside of the cylinder 101 as required. As described above, since the downstream feed port 107-3 is disposed downstream from the upstream feed port 107-1 and the intermediate feed port 107-2. The reason for this is as follows. When a large amount of the filler A is fed, the filler A needs to be intensively kneaded with the screw 102 in order to increase a dispersion ratio of the fillers A, and if doing so, there is a possibility of impairing a component of the filler B. For example, when the filler A is titanium oxide and the filler B is a fibrous filler such as glass fiber, if the filler B is fed from the same feed port as that of the liquid crystalline polyester or the titanium oxide (that is, if being fed from the upstream feed port 107-1 or the intermediate feed port 107-2), the fibrous filler B tends to be broken and consequently the effect of diffusing the fillers B (for example, the effect of increasing mechanical strength of the reflection plate formed of the resin composition) is reduced. On the other hand, in the present embodiment, since the filler B is fed from the downstream side of the upstream feed port 107-1 and the intermediate feed port 107-2, the filler B is hardly impaired and therefore the effect of diffusing the fillers B can be adequately secured.

In addition, a portion of the filler B may be fed from the upstream feed port 107-1 or the intermediate feed port 107-2, but it is desirable to feed 90% or more of the filler B from the downstream feed port 107-3.

Further, in the present embodiment, it is desirable that 90% or more of the thermoplastic resin (here, liquid crystalline polyester) is fed from the upstream feed port 107-1 and the intermediate feed port 107-2 and 90% or more of the filler A is fed from the upstream feed port 107-1 and the intermediate feed port 107-2, and it is more desirable that 60% or more of the thermoplastic resin is fed from the upstream feed port 107-1 and 30 to 70% of the filler A is fed from the intermediate feed port 107-2.

A strand thus extruded from the nozzle 110 is cut by various publicly known means to be processed into a pellet-like granulated substance (i.e., pellets). In cutting the strand, the strand may be previously solidified by cooling with air or water. A cutter to be used is not particularly limited but generally, a cutter formed by combining a rotary blade and a fixed blade into one is used.

When the above-mentioned additive is added to the resin composition, the additive may be fed from the feed ports 107-2 and 107-3 together with the filler A or the filler B, or may be mixed in the pellets. When the reflection plate is made of pellets, mixing of the additive in pellets makes it easier to attain excellent reflectance.

### <Production Step of Reflection Plate>

In the present embodiment, a reflection plate is produced by molding the above-mentioned pellets. In accordance with the present embodiment, by using a resin composition in which the fillers A are uniformly dispersed, a reflection plate superior in characteristics such as a reflectance and a heat conductivity can be obtained.

As a method for molding the pellets, various conventional techniques can be used and the molding method is not particularly limited. As the molding method, for example, an injection molding method, an injection compression molding method, an extrusion molding method or the like may be used, but the injection molding is particularly preferred. The injection molding is conducted at a molding temperature (setting temperature of a nozzle provided in an injection molding machine) preferably in a range of (Tm−20)° C. to (Tm+50)° C., more preferably in a range of (Tm−15)° C. to (Tm+30)° C., and particularly preferably in a range of (Tm−10)° C. to (Tm+20)° C., taking a flow temperature of the liquid crystalline polyester as Tm. The reason for this is that when the molding temperature is too low, the fluidity of the liquid crystalline polyester is deteriorated and there is a possibility that this low fluidity may cause the deterioration of moldability or a reduction in the strength of the reflection plate and when the molding temperature is too high, the degradation of the liquid crystalline polyester is intense and there is a possibility that this intense degradation may cause a reduction in a reflectance.

By such a production method, a reflection plate whose thin-wall part has adequately high mechanical strength can be produced. A thickness of the thin-wall part is preferably 0.03 to 3.0 mm, more preferably 0.05 to 2.0 mm, and particularly preferably 0.05 to 1.0 mm,

### <Light-Emitting Device>

The reflection plate thus produced can be used, for example, for optical reflection plates which are used in the fields of electricity, electronics, automobiles, machinery and the like and is suitable particularly for a reflection plate for visible light. The reflection plate is suitable for lamp reflectors of light source devices such as a halogen lamp, a high intensity discharge (HID) lamp and the like, and reflection plates of a light-emitting device or a display device, using the light-emitting element such as an LED (light emitting diode), an organic EL (electroluminescence) or the like.

Particularly, in the light-emitting device using, for example, an LED element, though the reflection plate is exposed to a high temperature environment in the element mounting step or the soldering step during the course of production, the reflection plate of the present embodiment has an advantage that deformation such as a blister is hardly produced in a high temperature process. Therefore, by using the reflection plate of the present embodiment, a light-emitting device, which is excellent in characteristics such as brightness and the like, can be obtained.

### EXAMPLES

Next, as examples of the present invention, the results of evaluating a feeding property in the production method of the above-mentioned embodiment will be described by use of Table 1. In the present examples, the conditions of production are as follows.

As the twin-screw extruding granulating machine, TEM 41SS, manufactured by Toshiba Machine Co., Ltd. (configuration of 13 barrels from C10 to C22), and PMT-47, manufactured by IKG Corp. (configuration of 10 barrels from C0 to C9), were employed.

The above-mentioned upstream feed port, intermediate feed port and downstream feed port were disposed in these twin-screw extruding granulating machines, respectively. In Table 1, a disposing position of each feed port is indicated by a number of a corresponding barrel.

A discharge rate represents a total weight [kg] per hour of the thermoplastic resin and the fillers A and B, charged into the twin-screw extruding granulating machine.

The results of evaluating a feeding property were rated from the viewpoint of mass production in consideration of machine performance, and the case having excellent mass production is denoted by ⊙, the case having usual mass production is denoted by ◯, the case having some low mass production is denoted by Δ, and the case having low mass production is denoted by x.

As the filler A, “TIPAQUE CR-60” (hereinafter, simply referred to as “CR-60”) and “TIPAQUE CR-58” (hereinafter, simply referred to as “CR-58”) (both manufactured by Ishihara Sangyo Kaisha, Ltd.) were used. CR-60 is titanium oxide surface treated with alumina, having an average particle diameter of 0.2 μm. CR-58 is titanium oxide surface treated with alumina, having an average particle diameter of 0.3 μm.

As the filler B, CS03JAPX-1 (manufactured by Owens Corning), EFDE90-01 (manufactured by Central Glass Co., Ltd.) and EFH75-01 (manufactured by Central Glass Co., Ltd.), which were 1glass fibers, were employed.

Hereinafter, methods for producing each sample used in evaluations described in Table 1 will be described.

### Example 1

First, into a reactor equipped with a stirrer, a torque meter, a nitrogen gas introducing tube, a thermometer and a reflux condenser, 994.5 g (7.2 mol) of para-hydroxybenzoic acid, 446.9 g (2.4 mol) of 4,4′-dihydroxybiphenyl, 358.8 g (2.16 mol) of terephthalic acid, 39.9 g (0.24 mol) of isophthalic acid and 1347.6 g (13.2 mol) of acetic anhydride were charged and 0.2 g of 1-methylimidazole was added. The atmosphere in the reactor was adequately replaced with a nitrogen gas and then heated to 150° C. over 30 minutes under a nitrogen gas stream, and the mixture was refluxed for one hour while maintaining the temperature.

Subsequently, an additional 1-methylimidazole (0.9 g) was added to the mixture, and the mixture was heated to 320° C. over 2 hours and 50 minutes while distilling off acetic acid produced as a by-product and unreacted acetic anhydride. After completion of the reaction, namely, an increase in torque was recognized, the mixture was cooled to room temperature to obtain a prepolymer.

Next, the resulting prepolymer was ground by a coarse grinder and the ground prepolymer was heated to 250° C. from room temperature over one hour under a nitrogen atmosphere, heated to 305° C. from 250° C. over 5 hours and maintained at 305° C. for 3 hours to perform the solid phase polymerization reaction. Thereafter, a reactant was cooled to obtain a liquid crystalline polyester. Hereinafter, this liquid crystalline polyester is referred to as “liquid crystalline polyester 1”. A flow temperature of the liquid crystalline polyester 1 was 357° C.

Fillers A and B were fed to the liquid crystalline polyester 1 in a compounded amount shown in Table 1 from feeding locations shown in Table 1 using a twin-screw extruder TEM 41SS and the resulting liquid crystalline polyester resin composition was melt-extruded to obtain a strand and the strand was cut to prepare pellets.

### Examples 2, 3, 5, Comparative Examples 2, 3 and Reference Example

The liquid crystalline polyester 1 and various fillers were mixed with a tumbler mixer, and then Fillers A and B were fed to the resulting mixture in a compounded amount shown in Table 1 from feeding locations shown in Table 1 using the twin-screw extruder TEM 41SS and the resulting liquid crystalline polyester resin composition was melt-extruded to obtain a strand and the strand was cut to prepare pellets.

### Example 4

A prepolymer was obtained in the same manner as in Example 1 except that the amount of terephthalic acid used was changed from 358.8 g (2.16 mol) to 299.0 g (1.8 mol); and the amount of isophthalic acid used was changed from 39.9 g (0.24 mol) to 99.7 g (0.6 mol).

The obtained prepolymer was ground by a coarse grinder and the ground prepolymer was heated to 250° C. from room temperature over one hour under a nitrogen atmosphere, heated to 285° C. from 250° C. over 5 hours and maintained at 285° C. for 3 hours to perform the solid phase polymerization reaction. Thereafter, a reactant was cooled to obtain a liquid crystalline polyester. Hereinafter, this liquid crystalline polyester is referred to as “liquid crystalline polyester 2”. A flow temperature of the liquid crystalline polyester 1 was 327° C.

Fillers A and B were fed to the liquid crystalline polyester 2 in a compounded amount shown in Table 1 from feeding locations shown in Table 1 using a twin-screw extruder TEM 41SS and the resulting liquid crystalline polyester resin composition was melt-extruded to obtain a strand and the strand was cut to prepare pellets.

### Examples 6 and 7

A prepolymer was obtained in the same manner as in Example 1 except that the amount of terephthalic acid used was changed from 358.8 g (2.16 mol) to 239.2 g (1.44 mol); and the amount of isophthalic acid used was changed from 39.9 g (0.24 mol) to 159.5 g (0.96 mol).

The obtained prepolymer was ground by a coarse grinder and the ground prepolymer was heated to 220° C. from room temperature over one hour under a nitrogen atmosphere, heated to 240° C. from 220° C. over 0.5 hours and maintained at 240° C. for 10 hours to perform the solid phase polymerization reaction. Thereafter, a reactant was cooled to obtain a liquid crystalline polyester. Hereinafter, this liquid crystalline polyester is referred to as “liquid crystalline polyester 3”. A flow temperature of the liquid crystalline polyester 1 was 291° C.

Fillers A and B were fed to the liquid crystalline polyesters 2 and 3 in a compounded amount shown in Table 1 from feeding locations shown in Table 1 using a twin-screw extruder TEM 41SS and the resulting liquid crystalline polyester resin composition was melt-extruded to obtain a strand and the strand was cut to prepare pellets.

### Comparative Example 1 and Reference Example 1

The above-mentioned liquid crystalline polyester 1 and various fillers were mixed with a tumbler mixer, and then Fillers A and B were fed to the resulting mixture in a compounded amount shown in Table 1 from feeding locations shown in Table 1 using the twin-screw extruder PMT 47 and the resulting liquid crystalline polyester resin composition was melt-extruded to obtain a strand and the strand was cut to prepare pellets.

As is apparent from Comparative Examples 1 to 3 in Table 1, in the conventional production method (method in which the liquid crystalline polyester and all titanium oxide are fed from the upstream feed port), a high feeding property was attained in the case where the amount of the supplied titanium oxide is small (Comparative Example 2), but the feeding property was deteriorated (Comparative Examples 1 and 3) with an increase in the amount of the supplied titanium oxide.

On the other hand, in Examples 1 to 7, an excellent feeding property could be attained regardless of the amount of the supplied titanium oxide. That is, as is apparent from Table 1, the feeding properties of Examples 1 to 7 were equal to those of Reference Examples 1 and 2 in which titanium oxide was not filled.

As described above, in accordance with the present embodiment, since the step of dispersing the fillers was separated into a treatment (first feed treatment) in which the thermoplastic resin is fed from an upstream side and a treatment (second feed treatment) in which the granular fillers are fed from a downstream side, the fillers could be more uniformly dispersed than a conventional method and the defective bite could be suppressed.

Accordingly, in accordance with the present embodiment, it is possible to provide a resin composition having less unevenness in characteristics such as an optical reflectance and a heat conductivity at low cost.

As a result of this, it is possible to provide a reflection plate having less unevenness in characteristics such as an optical reflectance and a heat conductivity and less product variations at low cost, and thereby it is possible to provide a light-emitting device having high characteristics at low cost.

TABLE 1

| | | Upstream feed port | | | Intermediate feed port | | | Downstream feed port | | | Discharge | |
|---|---|---|---|---|---|---|---|---|---|---|---|---|
| | | | Material | Parts by | | Material | parts by | | | Parts by | rate | Feeding |
| | Machine | Location | (*) | weight | Location | (*) | weight | Location | Material | weight | (kg/h) | property |
| Comparative | PMT47 | C0 | LCP 1 | 100 | none | | | C5 | EFDE90-01 | 27 | 50 | X |
| Example 1 | | | CR-58 | 55 | | | | | | | | |
| Comparative | TEM41SS | C10 | LCP 1 | 100 | none | | | C21 | EFH75-01 | 63 | 250 | ⊙ |
| Example 2 | | | CR-60 | 3 | | | | | | | | |
| Comparative | TEM41SS | C10 | LCP 1 | 100 | none | | | C21 | EFDE90-01 | 38 | 150 | Δ |
| Example 3 | | | CR-58 | 38 | | | | | | | | |
| Example 1 | TEM41SS | C10 | LCP 1 | 100 | C14 | CR-58 | 55 | C21 | EFDE90-01 | 27 | 170 | ◯ |
| Example 2 | TEM41SS | C10 | LCP 1 | 73 | C14 | LCP 1 | 27 | C21 | EFDE90-01 | 27 | 230 | ⊙ |
| | | | CR-58 | 27 | | CR-58 | 27 | | | | | |
| Example 3 | TEM41SS | C10 | LCP 1 | 100 | C14 | CR-58 | 27 | C21 | EFDE90-01 | 27 | 270 | ⊙ |
| | | | CR-58 | 27 | | | | | | | | |
| Example 4 | TEM41SS | C10 | LCP 2 | 100 | C14 | CR-58 | 27 | C21 | CS03JAPX-1 | 27 | 270 | ⊙ |
| | | | CR-58 | 27 | | | | | | | | |
| Example 5 | TEM41SS | C10 | LCP 1 | 100 | C14 | CR-58 | 37 | C21 | EFDE90-01 | 27 | 250 | ⊙ |
| | | | CR-58 | 18 | | | | | | | | |
| Example 6 | TEM41SS | C10 | LCP 2 | 55 | C14 | CR-60 | 40 | C21 | CS03JAPX-1 | 20 | 230 | ⊙ |
| | | | LCP 3 | 45 | | | | | | | | |
| | | | CR-60 | 40 | | | | | | | | |
| Example 7 | TEM41SS | C10 | LCP 2 | 55 | C14 | CR-60 | 55 | C21 | CS03JAPX-1 | 10 | 230 | ⊙ |
| | | | LCP 3 | 45 | | | | | | | | |
| | | | CR-60 | 55 | | | | | | | | |

| | | | | | | | | | | |
|---|---|---|---|---|---|---|---|---|---|---|
| Reference | PMT47 | C0 | LCP 1 | 100 | none | C5 | EFH75-01 | 67 | 80 | ◯ |
| Example 1 | | | | | | | | | | |
| Reference | TEM41SS | C10 | LCP 1 | 100 | none | C21 | EFH75-01 | 67 | >300 | ⊙ |
| Example 2 | | | | | | | | | | |

(*) LCP 1, LCP 2 and LCP 3 are the liquid crystalline polyester 1, the liquid crystalline polyester 2 and the liquid crystalline polyester 3, respectively.

What is claimed is:

1. A method for producing a resin composition comprising a thermoplastic resin and a filler dispersed therein, the method comprising:
providing an extrusion granulator that comprises (i) a cylinder provided with an extrusion outlet, a first feed port and a second feed port located downstream from the first feed port but upstream from the midpoint between the first feed port and the extrusion outlet and (ii) at least one screw mounted in the cylinder;
feeding the thermoplastic resin and the filler into the cylinder wherein the thermoplastic resin is fed through the first feed port and at least part of the filler is fed through the second feed port;
kneading the thermoplastic resin and the filler while transporting them towards the outlet by rotating the at least one screw to provide a mixture of them; and
extruding the mixture to produce the resin composition.

2. The method for producing a resin composition according to claim 1, wherein the whole thermoplastic resin and part of the filler are fed through the first feed port, and the rest of the filler is fed through the second feed port.

3. The method for producing a resin composition according to claim 1, wherein the filler is fed to the cylinder in an amount of from 20 parts by weight to 200 parts by weight based on 100 parts by weight of the thermoplastic resin.

4. The method for producing a resin composition according to claim 1, wherein the filler has a volume-average particle diameter of from 0.05 μm to 20 μm.

5. The method for producing a resin composition according to claim 1, wherein the thermoplastic resin is a liquid crystalline polyester and the filler is a filler made of an inorganic compound.

6. The method for producing a resin composition according to claim 5, wherein the inorganic compound is a titanium oxide.

7. The method for producing a resin composition according to claim 5, wherein the inorganic compound is a titanium oxide which has been surface-treated with an aluminum oxide.

8. The method for producing a resin composition according to claim 5, wherein the inorganic compound is a titanium oxide produced by a chlorine method.

9. The method for producing a resin composition according to claim 1, wherein the cylinder is further provided with a third feed port located downstream from the second feed port and wherein the method further comprises feeding another filler through the third feed port.

10. The method for producing a resin composition according to claim 9, wherein the another filler is a glass fiber.

11. A resin composition produced by the method according to claim 1.

12. A reflection plate produced by using the resin composition according to claim 11.

13. A light-emitting device comprising a light-emitting element and a reflection plate produced by using the resin composition according to claim 11 to reflect light emitted from the light-emitting element.
